(19) United States
(12) Patent Application Publication
(10) Pub. No.: US 2002/0184010 A1
(43) Pub. Date: Dec. 5, 2002

(54) Noise suppression

(76) Inventors: Anders Eriksson, Uppsala (SE); Tonu Trump, Bandhagen (SE)

Correspondence Address: NIXON & VANDERHYE P.C., 8th Floor, 1100 North Glebe Road, Arlington, VA, 22201, US

(21) Appl. No.: 10/105,884

(22) Filed: Mar. 26, 2002

(30) Foreign Application Priority Data
Mar. 30, 2001 (SE) 0101157-6
Jul. 13, 2001 (SE) 0102519-6

(51) Int. Cl. G10L 19/10; G10L 19/08

(52) U.S. Cl. 704/219

(57) ABSTRACT

A network noise suppressor includes means (113) for partially decoding a CELP coded bit-stream. Means (116) determine a noise suppressing filter H(z) from the decoded parameters. Means (118, 120) use this filter to determine modified LP and gain parameters. Means (122) overwrite corresponding parameters in the coded bit-stream with the modified parameters.

### TECHNICAL FIELD

The present invention relates to noise suppression in telephony systems, and in particular to network-based noise suppression.

### BACKGROUND

Noise suppression is used to suppress any background acoustic sound superimposed on the desired speech signal, while preserving the characteristics tics of the speech. In most applications, the noise suppressor is implemented as a pre-processor to the speech encoder. The noise suppressor may also be implemented as an integral part of the speech encoder.

There also exist implementations of noise suppression algorithms that are installed in the networks. The rationale for using these network-based implementations is that a noise reduction can be achieved also when the terminals do not contain any noise suppression. These algorithms operate on the PCM (Pulse Code Modulated) coded signal and are independent of the bit-rate of the speech-encoding algorithm. However, in a telephony system using low speech coding bit-rate (such as digital cellular systems), network based noise suppression can not be achieved without introducing a tandem encoding of the speech. For most current systems this is not a severe restriction, since the transmission in the core network usually is based on PCM coded speech, which means that the tandem coding already exists. However, for tandem free or transcoder free operation, a decoding and subsequent encoding of the speech has to be performed within the noise-suppressing device itself, thus breaking the otherwise tandem free operation. A drawback of this method is that tandem coding introduces a degradation of the speech, especially for speech encoded at low bit-rates.

### SUMMARY

An object of the present invention is a noise reduction in an encoded speech signal formed by LP (Linear Predictive) coding, especially low bit-rate CELP (Code Excited Linear Predictive) encoded speech, without introducing any tandem encoding.

This object is achieved in accordance with the attached claims.

Briefly, the present invention is based on modifying the parameters containing the spectral and gain information in the coded bit-stream while leaving the excitation signals unchanged. This gives noise suppression with improved speech quality for systems with transcoder free operation.

### BRIEF DESCRIPTION OF THE DRAWINGS

The invention, together with further objects and advantages thereof, may best be understood by making reference to the following description taken together with the accompanying drawings, in which:

FIG. 1 is a block diagram of a typical conventional communication system including a network noise suppressor;

FIG. 2 is a block diagram of another typical conventional communication system including a network noise suppressor;

FIG. 3 is a simplified block diagram of the CELP synthesis model;

FIG. 4 is a diagram illustrating the power transfer function of an LP synthesis filter;

FIG. 5 is a diagram illustrating the power transfer function of a noise-suppressing filter;

FIG. 6 is a diagram comparing the power transfer function of the original synthesis filter to the true and approximate noise suppressed filters;

FIG. 7 is a block diagram of a communication system including a network noise suppressor in accordance with the present invention;

FIG. 8 is a flow chart illustrating an exemplary embodiment of a noise suppression method in accordance with the present invention;

FIG. 9 is a series of diagrams illustrating the modification of the noise suppressing filter; and

FIG. 10 is a block diagram of an exemplary embodiment of a network noise suppressor in accordance with the present invention.

### DETAILED DESCRIPTION

In the following description elements performing the same or similar functions have been provided with the same reference designations.

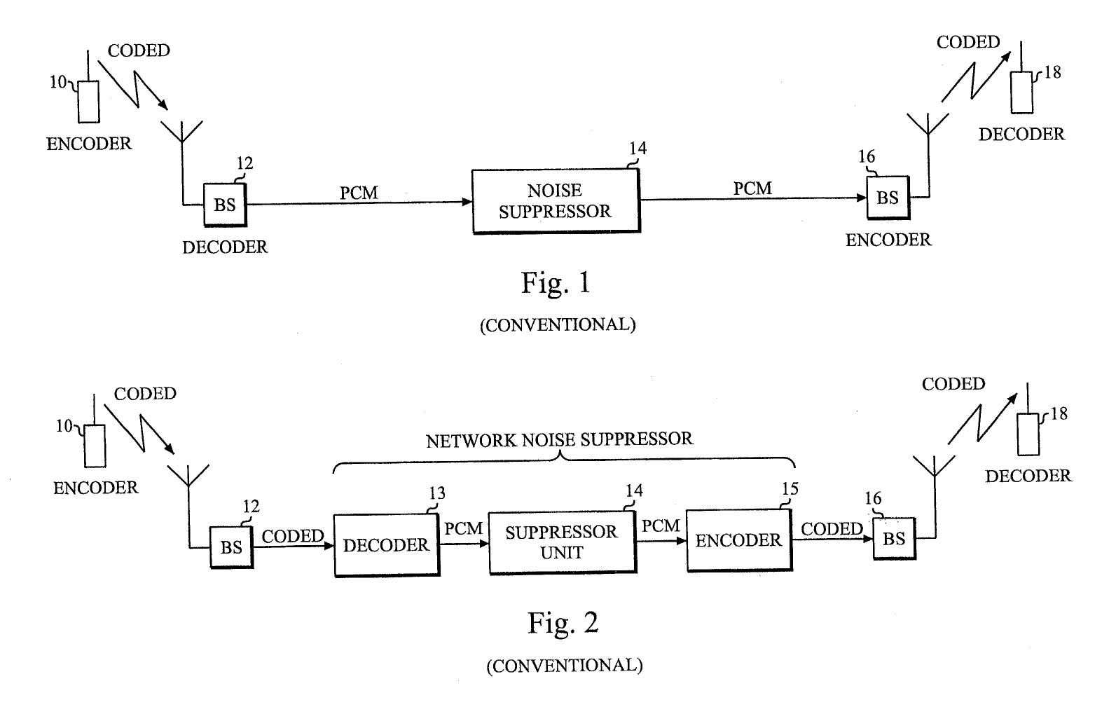

FIG. 1 is a block diagram of a typical conventional communication system including a network noise suppressor. A transmitting terminal 10 encodes speech and transmits the coded speech signal to a base station 12, where it is decoded into a PCM signal. The PCM signal is passed through a noise suppressor 14 in the core network, and the modified PCM signal is passed to a second base station 16, in which it is encoded and transmitted to a receiving terminal 18, where it is decoded into a speech signal.

FIG. 2 is a block diagram of another typical conventional communication system including a network noise suppressor. This embodiment differs from the embodiment of FIG. 1 in that the coded speech signal is also used in the core network, thereby increasing the capacity of the network, since the coded signal requires a lower bit-rate than a conventional PCM signal. However, the noise suppression algorithm used performs the suppression on the PCM signal. For this reason the network noise suppressor in addition to the actual noise suppressor unit 14 also includes a decoder 13 for decoding the received coded speech signal into a PCM signal and an encoder 15 for encoding the modified PCM signal. This feature is called tandem encoding. A drawback of tandem encoding is that at low speech coding bit-rates the encoding-decoding-encoding process leads to a degradation in speech quality. The reason for this is that the decoded signal, on which the noise suppression algorithm is applied, may not accurately represent the original speech signal due to the low coding bit-rate. A second encoding of this signal (after noise suppression) may therefore lead to poor representation of the original speech signal.

The present invention solves this problem by avoiding the second encoding step of the conventional systems. Instead of modifying the samples of a decoded PCM signal, the present invention performs noise suppression directly in the speech coded bit-stream by modifying certain speech parameters, as will be described in more detail below.

The present invention will now be explained with reference to CELP coding. However, it is to be understood that the same principles may be used for any type of linear predictive coding

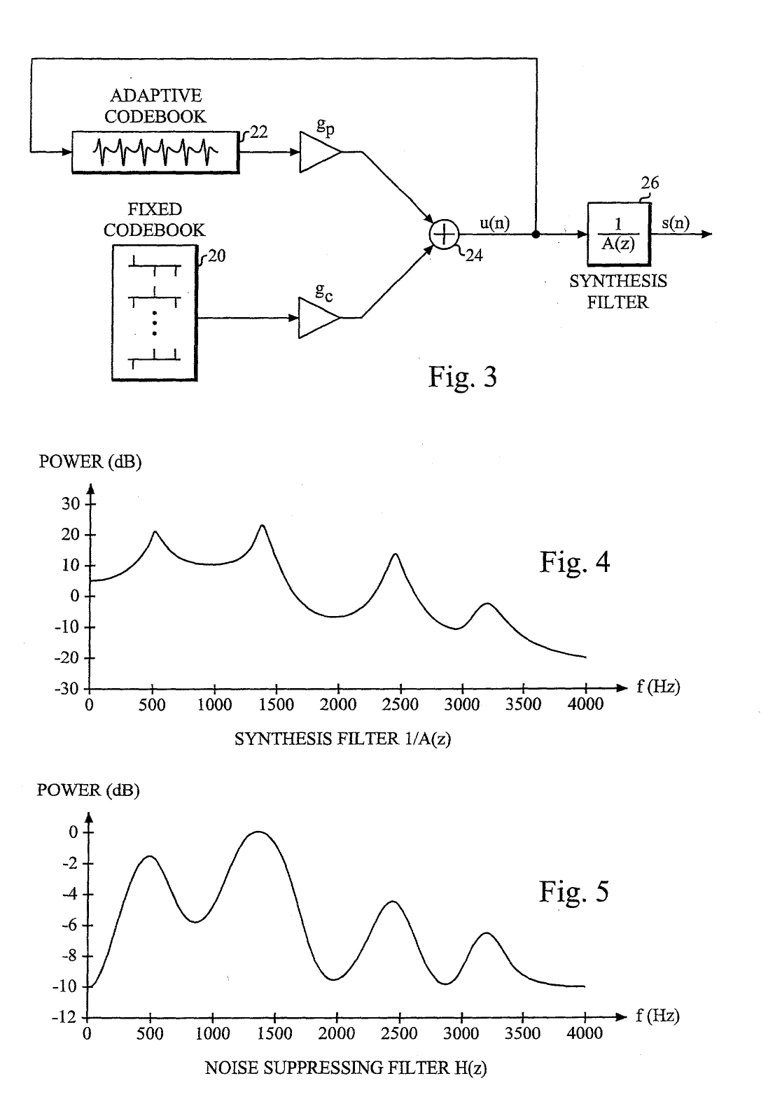

FIG. 3 is a simplified block diagram of the CELP synthesis model. Vectors from a fixed codebook 20 and an adaptive codebook 22 are amplified by gains gc and gp, respectively, and added in an adder 24 to form an excitation signal u(n). This signal is forwarded to an LP synthesis filter 26 described by a filter 1/A(z), which produces a speech signal s(n). This can be described by the equation

$$s ( n ) = \frac{1}{A ( z )} u ( n )$$

The parameters of the filter A(z) and the parameters defining excitation signal u(n) are derived from the bit-stream produced by the speech encoder.

A noise suppression algorithm can be described as a linear filter operating on the speech signal produced by the speech decoder, i.e.

y(n)=H(z)s(n)

where the (time-varying) filter H(z) is designed so as to suppress the noise while retaining the basic characteristics of the speech, see e.g. [1] for more details on the derivation of the filter H(z).

Now, applying the knowledge of how the speech decoder produces the decoded speech, a noise-suppressed signal can be achieved at the output of the speech decoder as

$$y ( n ) = H ( z ) s ( n ) = \frac{H ( z )}{A ( z )} u ( n )$$

The basic idea of the invention is to approximate the filter H(z)/A(z) with an AR (Auto Regressive) filter Ã(z) of the same order as A(z) and a gain factor α. Thus, the noise-suppressed signal at the output of the speech decoder can be approximated as

$$y ( n ) = H ( z ) s ( n ) = \frac{H ( z )}{A ( z )} u ( n ) \approx \frac{1}{\tilde{A} ( z )} α u ( n )$$

Hence, by replacing the parameters in the coded bit-stream describing the filter A(z) and the gain of the excitation signal with new parameters describing Ã(z) and a gain reduced by α, the noise suppression can be performed without introducing any complete decoding and subsequent coding of the speech.

FIG. 4 is a diagram illustrating the power transfer function of an LP synthesis filter. It is characterized by peaks at certain frequencies interconnected by valleys.

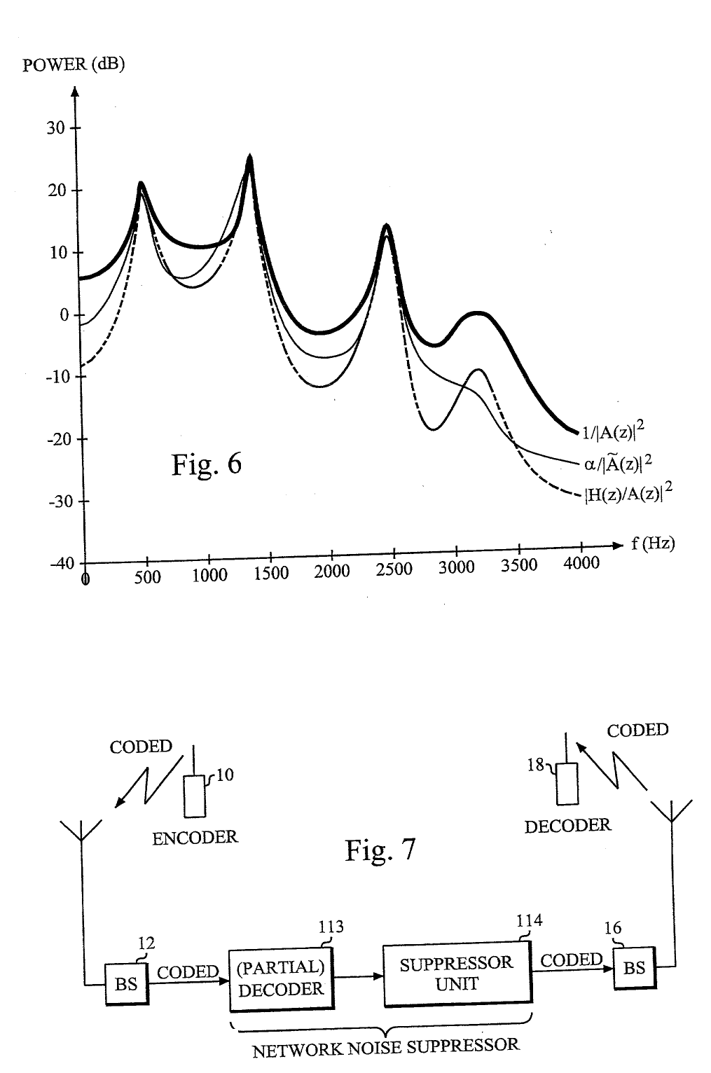

FIG. 5 is a diagram illustrating the power transfer function of a noise-suppressing filter. It is noted that it has peaks at approximately the same frequencies as the spectrum in FIG. 4. The effect of applying this filter to the spectrum in FIG. 4 is to sharpen the peaks and to lower the valleys, as illustrated by FIG. 6, which is a diagram comparing the power transfer function of the original synthesis filter to the true and approximate noise suppressed filters.

FIG. 7 is a block diagram of a communication system including a network noise suppressor in accordance with the present invention. As can be seen from FIG. 7, the encoder between noise suppressor unit 114 and base station 16 has been eliminated. According to the invention, noise suppression is performed directly on the parameters of the coded bit-stream, which makes the encoder unnecessary. Furthermore, decoder 113 may perform either a complete or a partial decoding, depending on the algorithm used, as will be described in further detail below. In both cases the decoding is only used to determine the necessary modification of parameters in the coded bit-stream.

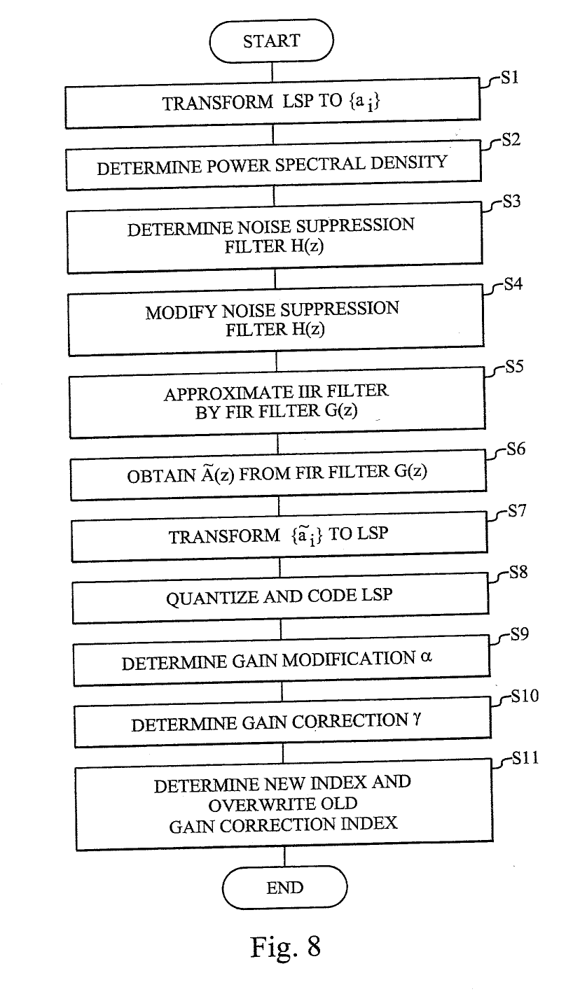

As an example of how the modification of the bit stream is performed, the application of the present invention to the 12.2 kbit/s mode of the Adaptive Multi-Rate (AMR) speech encoder for the GSM and UMTS systems [2] will now be described with reference to FIG. 8. However, the present invention is not limited to this speech codec, but can easily be extended to any speech codec for which a parametric spectrum and a coded innovation sequence are part of the coded parameters. As seen from FIG. 3, the parameters to be modified in order to achieve the noise reduction are the parameters describing the LP synthesis filter A(z) and the gain of the fixed codebook gc. The codewords representing the fixed and adaptive codebook vectors do not have to be altered and neither does the adaptive codebook gain gp (in this mode). The procedure can be summarized by the following steps, which are illustrated in FIG. 8.

S1. The first step is to transform the quantized LSP (Line Spectral Pair) representing filter A(z) to the corresponding filter coefficients {aᵢ}, as described in [2], section 5.2.4.

S2. In order to determine the noise suppressing filter H(z) a measure of the power spectral density \hat{Φ}ₓ(k) of the coded speech signal is required. Using the determined filter coefficients {aᵢ} this can be found as

$${\hat{Φ}}_{x} ( k ) = \frac{{σ}^{2}}{\vert 1 + {\sum }_{m = 1}^{M} {a}_{m} {ⅇ}^{- jπ m \frac{k}{K}} {\vert}^{2}}$$

where σ² is obtained from the fixed codebook gain g_{c} and adaptive codebook gain gₚ in accordance with

σ²=g_{c}²+gₚ²???

Another possibility is to completely decode the speech signal and to use the fast Fourier transform to obtain \hat{Φ}ₓ(k).

S3. Determine the noise suppressing filter H(z) as

$$H ( k ) = {( 1 - {δ ( \frac{{\hat{Φ}}_{v} ( k )}{{\hat{Φ}}_{x} ( k )} )}^{λ} )}^{β}$$

where \hat{Φ}ᵥ(k) is the saved power spectral density from an earlier “pure noise” frame and β,δ, λ are constants.

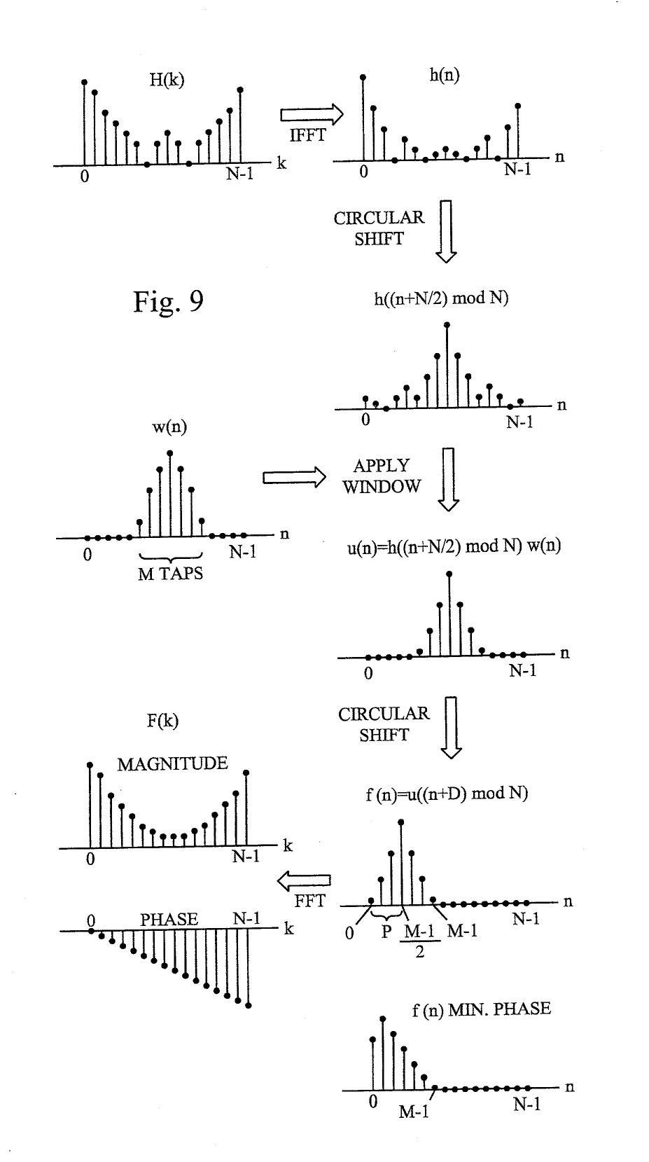

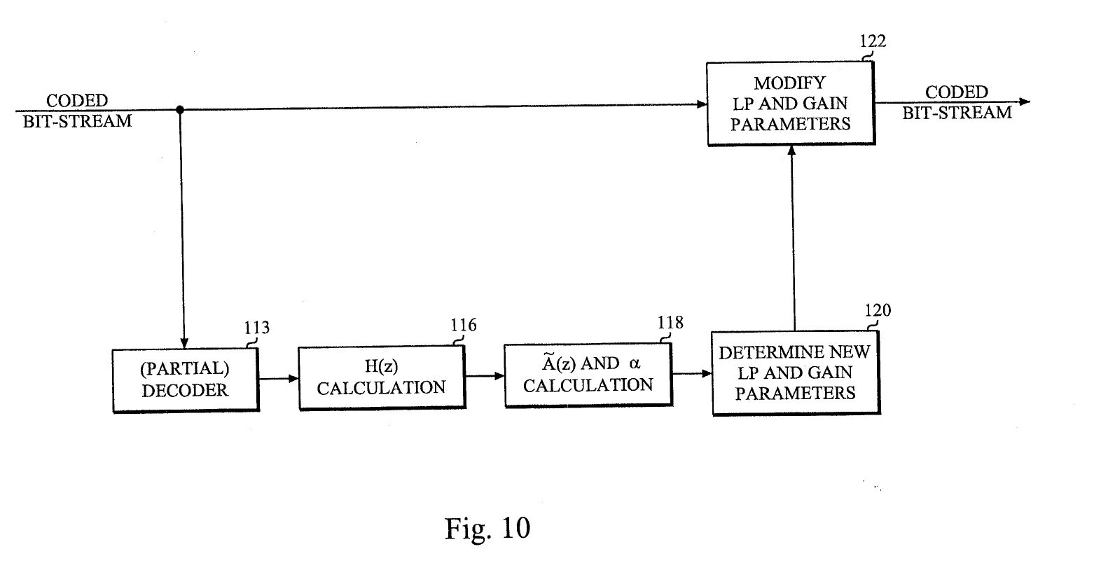

S4. Modify the filter defined by H(k) as described in [1]. This gives the desired H(z). The reason for the modification is that noise suppressing filters designed in the frequency domain are real-valued, which leads to a time domain representation in which the peak of the filter is split between the beginning and end of the filter (this is equivalent to a filter that is symmetric around lag 0, i.e. a non-causal filter). This makes the filter unsuitable for circular block convolution, since such a filter will generate temporal aliasing. The performed modification is outlined in FIG. 9. It essentially involves transforming H(k) to the time domain, circularly shifting he transformed filter to make it causal and linear phase, applying a window (to avoid time domain aliasing) to the shifted filter to extract the most significant taps, circularly shifting the windowed filter to remove the initial delay, and (optionally) transforming the linear phase filter to a minimum phase filter. An alternative modification method is described in [3].

S5. Approximate the IIR (Infinite Impulse Response) filter defined as H(z)/A(z) by a FIR (Finite Impulse Response) filter G(z) of length L. The coefficients of G(z) may be found as the first L coefficients of the impulse response g(k) of H(z)/A(z) or by performing the polynomial division H(z)/A(z) and identifying the coefficients for the z⁻¹ . . . z^{-L} terms.

S6. Obtain Ã(z) from the auto correlation function

$$r ( k ) = {\sum }_{l = 0}^{L} g ( l ) g ( l - k )$$

of G(z) using the Levinson-Durbin algorithm, see [2] section 5.2.2.

S7. Transform the coefficients ãᵢ} that define Ã(z) into modified LSP parameters as described in [2], section 5.2.3

S8. Quantize and code modified LSP parameters as described in [2], section 5.2.5 and replace the AR parameter code in the bit-stream.

S9. The fixed codebook gain modification α is defined by square root of the prediction error power, which is calculated in the same way as ELD in [2] section 5.2.2.

S10. For the gain of the excitation signal the procedure in section 6.1 of [2] is used. The fixed codebook gain is given by

\tilde{g}_{c}=γ(n)g′_{c}

where the factor γ(n) is the gain correction factor transmitted by the encoder. The factor g′_{c} is given by

g′_{c}=10^{0.05(\tilde{E}(n)+\overline{E}-E}^{ₗ}⁾

where \overline{E} is a constant energy, Eₗ is the energy of the codeword, and

$$\tilde{E} ( n ) = {\sum }_{i = 1}^{4} {b}_{i} \hat{R} ( n - i )$$

where \hat{R}(n) are past gain correction factors in a scaled logarithmic domain.

The noise suppression algorithm modifies the gain by the factor α. Thus, the gain in the decoder should equal α times the gain in the encoder, i.e.

ĝ_{c}^{dec}=αĝ_{c}^{enc}

Using the expressions above it is found that

γ^{new}(n)10^{0.05(\tilde{E}}^{^{dec}}^{(n)+\overline{E}-E}^{ₗ}⁾=αγ(n)10^{0.05(\tilde{E}}^{^{enc}}^{(n)+\overline{E}-E}^{ₗ}⁾

Hence, the transmitted gain correction factor should be replaced by

γ^{new}(n)=αγ(n)10^{0.05(\tilde{E}}^{^{enc}}^{(n)-\tilde{E}}^{^{dec}}⁽ⁿ⁾⁾

where \tilde{E}^{enc}(n) and \tilde{E}^{dec}(n) are the predicted energies based on the gain factors transmitted by the encoder and the gain factors modified by the noise suppression algorithm.

S11. Find the index of the codeword closest to γ^{new}(n) and overwrite the original fixed codebook gain correction index in the coded bit-stream.

In the described example the fixed and adaptive codebook gains are coded independently. In some coding modes with lower bit-rate they are vector quantized. In such a case the adaptive codebook gain will also be modified by the noise suppression. However, the excitation vectors are still unchanged.

FIG. 10 is a block diagram of an exemplary embodiment of a network noise suppressor in accordance with the present invention. The received coded bit-stream is (partially) decoded in block 113. Block 116 determines the noise suppressing filter H(z) from the decoded parameters. Block 118 calculates Ã(z) and α. Block 120 determines the new linear predictive and gain parameters. Block 122 modifies the corresponding parameters in the coded bit stream. Typically the functions performed in the network noise suppressor are realized by one or several micro processors or micro/signal processor combinations. However, the same functions may also be realized by application specific integrated circuits (ASIC).

It will be understood by those skilled in the art that various modifications and changes may be made to the present invention without departure from the scope thereof, which is defined by the appended claims.

### REFERENCES

[1] WO 01/18960 A1

[2] “AMR speech codec; Transcoding functions”, 3G TS 26.090 v3.1.0, 3GPP, France, 1999.

[3] H. Gustafsson et al., “Spectral subtraction using correct convolution and a spectrum dependent exponential averaging method”, Research Report 15/98, Department of Signal Processing, University of Karlskrona/Ronneby, Sweden, 1998

1. A noise suppression method including the steps of
representing a noisy signal by a bit stream formed by signal encoding based on linear predictive coding; and
suppressing noise by modifying predetermined coding parameters directly in the encoded bit stream.

2. The method of claim 1, wherein said encoding is based on code excited linear predictive coding.

3. The method of claim 2, including the step of modifying parameters defin- ing a linear predictive synthesis filter.

4. The method of claim 3, including the step of modifying at least one code- book gain.

5. The method of claim 4, including the step of modifying the fixed codebook gain.

6. The method of claim 1, including the step of modifying line spectral pair parameters and a fixed codebook gain correction factor.

7. The method of claim 1, wherein predetermined parameters are kept unchanged.

8. The method of claim 7, wherein fixed codebook vectors are kept unchanged.

9. A noise suppression system including
means for representing a noisy signal by a bit stream formed by signal encoding based on linear predictive coding; and
means for suppressing noise by modifying predetermined coding parameters directly in the encoded bit stream.

10. The system of claim 9, including means for modifying parameters defining a linear predictive synthesis filter.

11. The system of claim 10, including means for modifying at least one codebook gain.

12. The system of claim 11, including means for modifying the fixed codebook gain.

13. The system of claim 9, including means for modifying line spectral pair parameters and a fixed codebook gain correction factor.

14. A network noise suppressor including
means for receiving a bit stream representing a noisy signal, said bit stream being formed by signal encoding based on linear predictive coding and; and
means for suppressing noise by modifying predetermined coding parameters directly in the encoded bit stream.

15. The suppressor of claim 14, including means for modifying parameters defining a linear predictive synthesis filter.

16. The suppressor of claim 15, including means for modifying at least one codebook gain.

17. The suppressor of claim 16, including means for modifying the fixed codebook gain.

18. The suppressor of claim 14, including means for modifying line spectral pair parameters and a fixed codebook gain correction factor.
